(19) United States
(12) Patent Application Publication
(10) Pub. No.: US 2010/0042776 A1
(43) Pub. Date: Feb. 18, 2010

(54) Method and apparatus for providing enhanced write performance using a buffer cache management scheme based on a buffer replacement rule

(76) Inventors: Dong Young Seo, Hwaseong-si (KR); Dong Kun Shin, Gwacheon-si (KR)

Correspondence Address: LEE & MORSE, P.C., 3141 FAIRVIEW PARK DRIVE, SUITE 500, FALLS CHURCH, VA, 22042, US

(21) Appl. No.: 12/457,425

(22) Filed: Jun. 10, 2009

(30) Foreign Application Priority Data
Aug. 18, 2008 (KR) 10-2008-0080510

(51) Int. Cl. G06F 12/08; G06F 12/02

(52) U.S. Cl. 711/103; 711/133; 711/E12.008; 711/E12.017

(57) ABSTRACT

An approach is provided for improving write performance using a buffer cache based on a buffer replacement policy. A buffer cache manager is configured to improve address mapping scheme associated with write performance between an application system and a storage device system. The manager selects a victim page to be evicted from a victim block of a buffer cache according to a recently-evicted-first rule. And the victim block is selected associated with a log block of a memory.

### RELATED APPLICATIONS

This U.S. non-provisional patent application claims benefits of priority under 35 U.S.C. §119 of Korean Patent Application No. 10-2008-80510 filed on Aug. 18, 2008, the entirety of which is incorporated herein by reference.

### FIELD OF THE INVENTION

Various exemplary embodiments of the invention relate to a memory system, and more particularly, to a buffer cache management scheme for applications using a flash memory device and its system.

### BACKGROUND

Flash memories have been widely used as storage device for consumer systems such as MP3 players, digital cameras, and personal digital assistants (PDA). With increasing use of portable consumer devices such as MP3 players, digital cameras, personal digital assistances and cell phones, the market of NAND flash memories is sprightly extending in recent years since NAND flash memory has many advantages over hard disk drive i.e., low-power consumption, small size and high shock resistance. Moreover, general purpose systems such as desktop PC are also going to use flash memory. For example, hybrid hard disks, on-board disk cache and turbo memories use flash memory as a nonvolatile cache of hard disk drive. Eventually, solid state disks (SSD) based on NAND flash memories are expected to replace the traditional hard disks.

Unlike a traditional hard disk drive, flash memory provides high read performance without a seeking time, however, the flash memory does not support overwrite operations because of its write once nature, thus, basically has two characteristics which constrain the writing performance. One of obstacles to its wide use is the slow write performance of flash memory caused by its ‘erase-before-write’ scheme—a block must be erased before writing data into the block. Another obstacle involves an erasing operation that should be performed in the unit of block while a writing operation can be performed in the unit of page. The special features of flash memory require two management schemes. First, an address mapping scheme, which maps the logical address from the file system to the physical address of flash memory by maintaining an address mapping table. Second scheme, to reclaim the invalidated pages, employs selecting a block which has many invalid pages and erase the block to be reused after migration the valid pages in the block to clean the block. However, as the write pattern becomes more random, the space utilization of the log buffer of flash memory becomes worse because even a single page update of the data block requires a whole log block. Consequently, when a large number of small-sized random writes are issued form the file system, most of log blocks are selected as victim blocks with only a small portion of the block being utilized. Such a phenomenon where most write requests invoke block merge called log block thrashing. To prevent log block thrashing problem, a mapping scheme where a log block ca e used for multiple data blocks, however, this scheme possesses high block associability problem. In order to support these two management tasks, a flash translation layer (FTL) is commonly used between the file system and memory system including flash memory. However, most existing FTL schemes have drawbacks that show poor write performance in terms of random write request due to the block thrashing problem and high block associability.

Therefore, there is a need for an approach to provide more efficient management scheme capable of enhanced write performance.

### SOME EXEMPLARY EMBODIMENTS

These and other needs are addressed by the embodiments of the invention, in which an approach is presented for enhancing write performance using a buffer cache management scheme based on a buffer replacement rule.

According to one aspect of an embodiment of the invention, a method comprises selecting a victim block from a buffer cache based on recent page eviction, wherein the victim block is selected in consideration of a current log block of memory. The method also comprises inserting a new page by evicting the victim page from the buffer cache in consideration of the priority of the recent victim page sent to a log block of a memory system.

According to another aspect of an embodiment of the invention, an apparatus comprises a buffer cache manager configured to improve address mapping scheme associated with write performance between an application system and a storage device system. The manager selects a victim page to be evicted from a victim block of the buffer cache according to a recently-evicted-first rule. The victim block is selected associated with a log block of a storage device system.

According to yet another aspect of an embodiment of the invention, a computer-readable medium carrying one or more sequences of one or more instructions for improving write performance between a host and a memory, the one or more sequences of one or more instructions including instructions which, when executed by one or more processors, cause the one or more processors to perform the steps. The step comprises receiving a write request. The step also comprises selecting a victim block from a buffer cache according to recently-evicted-first buffer replacement rule, wherein the victim block is associated with a log block of the memory. The step further comprises enforcing the buffer cache to evict a page of the victim block according to the recent history of the buffer cache eviction. An the step includes inserting a new page into the buffer cache.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a block diagram of a management system capable of enhanced write performance associated with a translation layer between a file system and a memory system having a buffer cache management scheme based on a buffer replacement policy in accordance with an embodiment of the invention;

FIG. 2 is a diagram illustrating a buffer management scheme in consideration of log block of memory system using a 1:1 log block mapping, in accordance with an embodiment of the invention;

FIG. 3 is a diagram illustrating a buffer management scheme in consideration of log block of memory system using 1:N log-block mapping scheme, in accordance with an embodiment of the invention;

FIG. 4 is a diagram illustrating selection of a victim block from buffer cache based on recently-evicted-first buffer replacement policy, in accordance with an embodiment of the invention;

FIGS. 5A and 5B are flowcharts of processes for providing a buffer cache management scheme, in accordance with various embodiments of the invention;

FIG. 6 is a diagram of hardware that can be used to implement various embodiments of the invention; and

FIG. 7 is a diagram of exemplary components of a memory system capable of supporting the cache buffer management scheme and processes, in accordance with an embodiment of the invention.

### DETAILED DESCRIPTION OF PREFERRED EMBODIMENTS

A device, method and software for providing a buffer cache management scheme are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a flash memory system, it is recognized by one of ordinary skill in the art that the embodiments of the inventions have applicability to any type of memory and/or cache that exploits buffer replacement policy associated with write request for enhanced conducting reorders and clusters to reduce overhead.

The address mapping scheme utilizing flash translation layers (FTL) is generally classified into three modes, i.e., block-level mapping, page-level mapping, and hybrid mapping. According to the bock-level mapping, a mapping table retains mapping information between logical block address and physical block address. Thus, a logical page can be written by an in-place scheme. This means that page data is written in a fixed location of a block defined by a page offset within the block. The block-level mapping needs a small-sized mapping table. But, when a specific page of block is requested to be modified, a specified block should be erased and pages not to be changed as well as to be changed should be copied into a new block. This constraint incurs high migration overhead, thus degrading the writing performance.

In the page-level mapping, a mapping table retains mapping information between logical address and physical page addresses. Thus, a logical page can be mapped by an out-of-place scheme. Namely, page data can be written to any physical page in a block. If a request for updating old page data that is already written into the flash memory, the FTL writes new data to a different empty page and changes the page-level mapping information. The old page data is nullified by notification at a reserved space of the flash memory. However, due to an inevitable large scale of mapping table, the page-level mapping has a drawback.

The hybrid mapping scheme uses both of the page-level mapping and block-level mapping. In this scheme, all the physical blocks are divided into log blocks and data blocks. The log blocks are also called log buffers. For that reason, an FTL using the hybrid mapping scheme is also referred to as log-buffer based FTL. The log blocks are operable using the page-level mapping and the out-of-place scheme, and the data blocks are processed by the block-level mapping and the in-place scheme. Responding to a write request, the FTL transfers data to a log block and nullifies corresponding old data in data block.

If there is no unused space because the log blocks are full of data, one log block is selected as a victim and all the valid pages in the selected log block are moved into data blocks to ready for receiving write requests. In this operation, the log block is merged with data blocks which correspond to the log block. Consequently, this operation is usually called block merging process. The block merging process can be classified into three modes: full merging mode, partial merging mode, and switch merging mode. The partial and switch merging modes can be conducted if all the pages of a block are written by the in-place scheme. While the full merging mode requires many pages for copying and blocks for erasing, the partial merging mode and switch merging mode can be operable with minor cost for page shifting. Therefore, the hybrid mapping is able to reduce page shift cost compared to the block-level mapping scheme with a small-sized mapping table.

To improve the input/output performance of flash memory system, it is required to reduce overheads caused by block merging operations. Therefore, FTL schemes mostly aim to decreasing the number of block merging times. Since flash memory system is designed for multimedia systems such as MP3 player and digital cameras that manly requires only sequential write pattern, the current FTL technologies are focused on sequential writing patterns. However, as flash memory technologies quickly improve, flash-memory-based storage devices are becoming a viable alternatives as a secondary storage solution for general purpose computing systems such as personal computers and enterprise server system, it is increasingly demand multiple processes capable of dealing with both sequential and random writing requests within FTL technology.

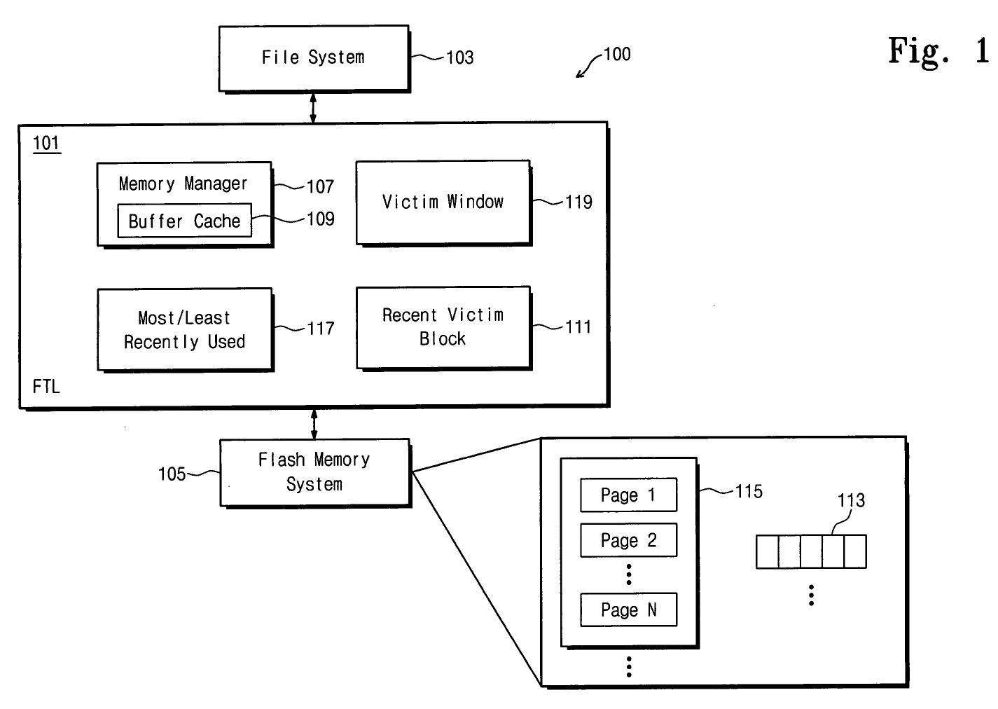

These and other needs are addressed by the invention in which FIG. 1 is a block diagram of a management system capable of write performance associated with a translation layer between file system and memory system having a buffer cache management scheme based on a buffer replacement policy in accordance with an embodiment of the invention.

As seen in FIG. 1 the system 100 utilizes flash translation layers (FTL) 101 that maps logical page addresses of file system 103 into physical addresses of flash memory system 105. In an exemplary embodiment, memory manager 107 can be deployed to a management system 100 to improve the write performance of flash memory system 105 using a flash aware buffer cache replacement policy. This management scheme includes to select victim page to be evicted from buffer cache 109 in consideration of recent victim page from recent victim block 111 sent to flash memory log block (or buffer) 113. For the purpose of illustration, flash memory 105 comprises data block 115 which governs block level managed block, and log block 113 which governs page level managed block. Log block 113 can be a temporary storage typically for small size write to data block. The buffer cache 109 can reduce the number of write requests sent to the flash system 105 by merging repeated write requests. The flash aware buffer cache replacement policy of buffer cache 109 can determine the flash memory system write pattern. This policy considers log buffer 113 of flash memory system 105. This policy can be called recently-evicted-first since it gives high priorities to the pages of the block whose pages are recently evicted to the log buffer 113 of flash memory system 105. By way of example, a victim block can be selected using blocks from most/least-recently-used register 117. It is noted that the policy selects the blocks to be included into victim block (VB) selected by memory manager 107 using victim window (VW) 119 to prevent the recently-used pages from being evicted.

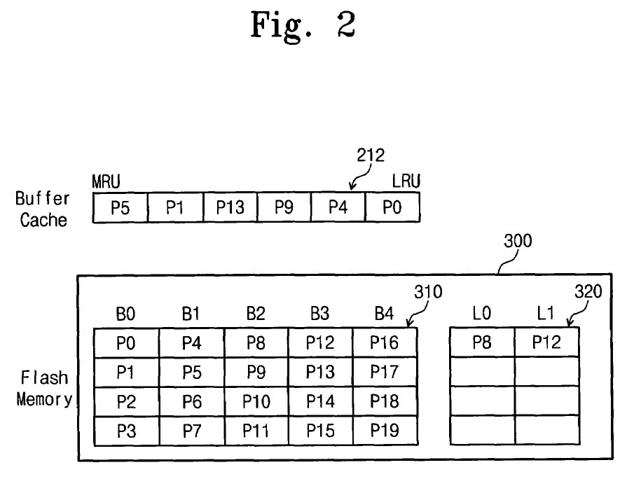

FIG. 2 is a diagram illustrating a buffer cache management in consideration of log block of memory system using a 1:1 log block mapping, in accordance with an embodiment of the invention. Under this circumstance, to select victim blocks which are associated with log blocks, the recently-evicted-first policy determines the victim blocks considering recent page eviction. By way of example, it is assumed that a buffer cache has pages “p0, p4, p9, p13, p1 and p5” in a least recently used (LRU) order, two log buffers has the pages p8 and p12 and the log buffer can be managed by a 1:1 log block mapping. If the system uses the LRU page replacement policy, the pages are evicted by the order of “p0, p4, p9, p13, p1, p5” and six (6) number of log block merges are invoked. However, if the system reorders the page eviction, the system can reduce the number of block merge. Since the log blocks are associated with the data blocks B2 and B3, it is better to evict the pages of B2 and B3 first, i.e., p9 and p13. Therefore, if the buffer cache flushes the page by the sequence of “p9, p13, p0, p4, p1, p5,” advantageously only two number of log block merges are required.

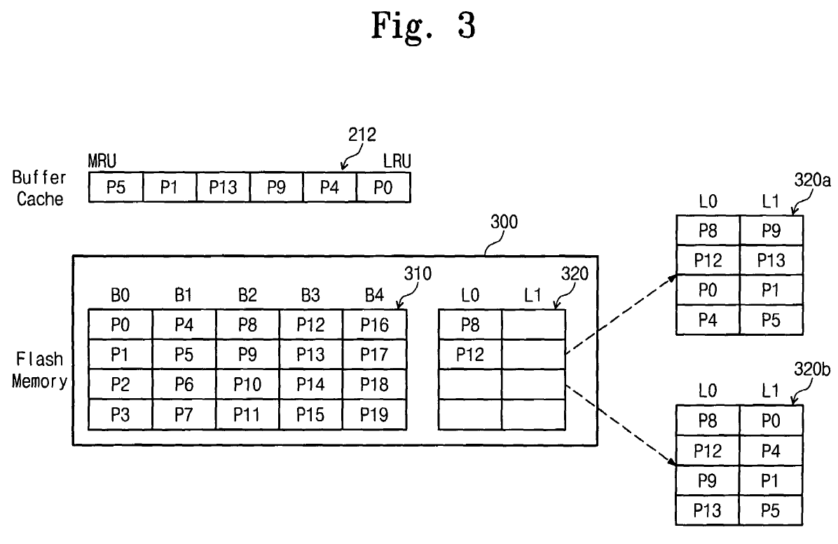

FIG. 3 is a diagram illustrating a buffer cache management in consideration of log block of memory system using 1:N log-block mapping scheme, in accordance with an embodiment of the invention.

It is contemplated that under this scheme the block associability of each log block can be reduced by recently-evicted-first policy. As seen in FIG. 3, it is now assumed that the page data p8 and p12 are stored in the log block L0 of the log field 320. In this example, a first storage pattern 320a of each block (L0 and L1) is resulted from when pages are evicted from the buffer cache 212 in the sequence of using the least-recently used (LRU), namely, in the order of p0, p4, p9, p13, p1, and p5. A second storage pattern 320b is resulted from when pages data are evicted from the buffer cache 109 in the sequence of using the recently-evicted-first (REF) in the order of p9, p13, p0, p4, p1, and p5. The second storage pattern utilized by the REF yields the advantages effect of reducing block associative of log block. It is noted that the log blocks L0 and L1 of the log field 320 are involved in the block associability. As a result, the block associability of the log blocks L0 and L1 of the log field 320b is reduced to 2. Therefore, it is recognized utilizing the REF within a buffer cache management scheme associated with considering of log block is reducing the block associability of the log block and the number of block merging times.

According to various of embodiments of the invention, the buffer cache management scheme involves three main characteristics. Firstly, it is contemplated that eviction is performed in block level. For reducing the block associability and block merging times, only page data of victim blocks are evicted from the buffer cache 109. It should be understood that the overhead reduction associated with block associability and block merging improves a performance over the scheme using the LRU replacement policy. Secondly, maintain victim blocks as compatible as data blocks associated with log blocks as possible. This makes all page data of the block evicted at the same time that enables to reduce cost of block merging. Thirdly, regarding to the latest page data level, that is, in order to prevent the latest page data from being evicted, the victim page is selected from not recently used.

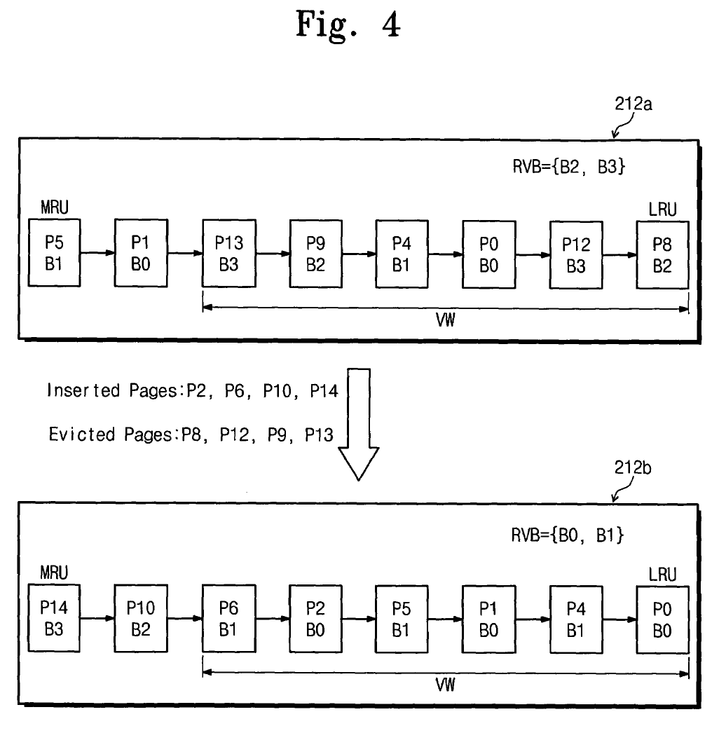

FIG. 4 is a diagram illustrating selection of a victim block from buffer cache based on recently-evicted-first buffer replacement policy, in accordance with an embodiment of the invention.

As regards to FIG. 4, it is assumed that the buffer cache 128a is able to store eight pages and each page is stored in the LRU sequence. Based on recently-evicted-first (REF) policy, memory manager maintains the set of victim block (VB). The memory manager enforces the buffer cache to evict only the pages of victim block. By way of example, in the beginning process, the RVB register of FIG. 1 is empty. To prevent an effect of log block thrashing, the number of the recent victim blocks must be smaller than the number of log blocks of the flash memory. Under this scheme, the size of victim block (VB) is two (2).

A victim window VW of FIG. 1 can be used for prevent recently-used pages from being evicted. By way of example, the size of victim window is 75%. In this case, six pages (75% of 8 pages) can be included in the victim window (VW) in the order of the least-recently-used (LRU). In this way, memory manager can find two blocks which has the largest number of pages within the victim window (VW). First, the blocks B2 and B3 can be selected as the victim blocks (VB). Then, the memory manager compose the victim page list with all the pages which are located within the victim window (VW) and whose corresponding block is in the victim block (VB).

If it is permissible for any page data to be selectable in the buffer cache 212a, the least-recently-used page is selected from the buffer cache 212a In case the log buffer 320 is empty or page data of the victim window, VW is included in the same block. The LRU register 230 of FIG. 1 stores information of the least-recently-used page data. If page of a block corresponding to the recent victim block RVB is located out of the victim window VW in the buffer cache 212a, the page data can be introduced into the victim window VW after evicting another page from the buffer cache 212a.

As seen in the FIG. 4 it is illustrated that the page data p8, p12, p9, and p13 are evicted while new page data p2, p6, p10, and p14 are requested to be added. If there is no page remains at the buffer cache 212a because all victim page data have been flushed into the flash memory 300, it is necessary to form new recent victim blocks (RVB). In this example, the new RVB includes B0 and B1.

It is noted that a size of the victim window (VW) should be carefully selected in consideration for positions of writing patterns. If the victim window (VW) is sized too large, the latest page data is evicted to raise a miss ratio of the buffer cache 212. If the victim window VW is sized too small, it operates as similar to the conventional LRU scheme and thereby incurs a thrashing of log blocks. A size of the victim window VW may be set by way of a test operation using desktop benchmarking applications, which is preferred to be about 75% of the total size of the buffer cache 109.

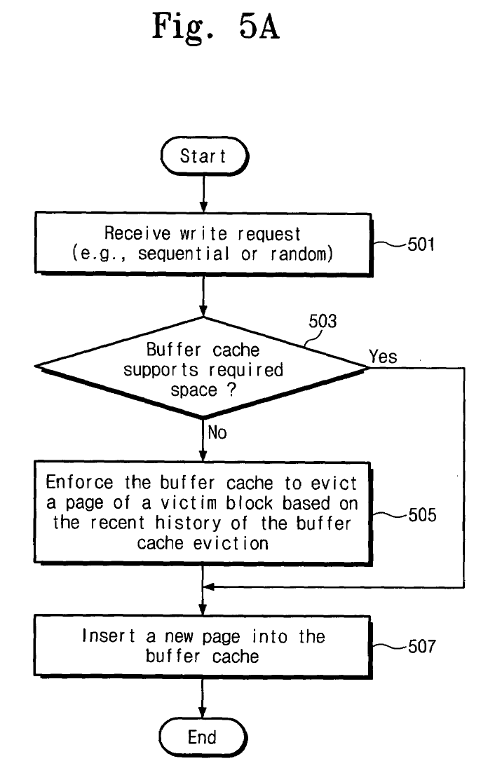

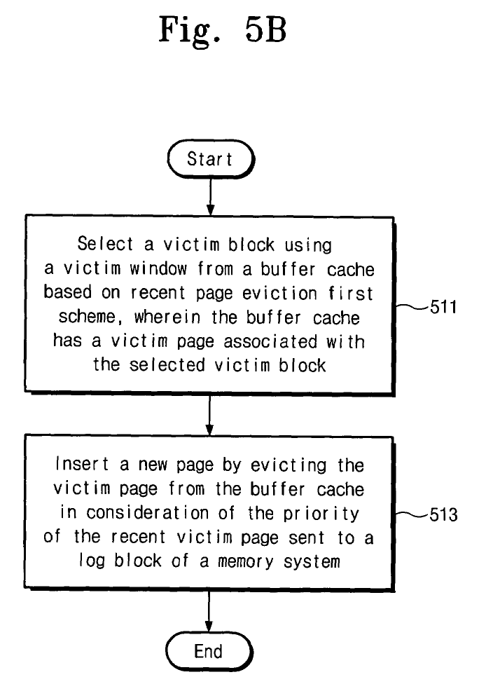

FIGS. 5A and 5B are flowcharts of processes for providing a buffer cache management scheme, in accordance with an embodiment of the invention.

For the purposes of illustration, this buffer cache management scheme process is described in FIG. 5A with respect to a file system and memory system. The memory manager, in step 501, receives write request which covers sequential write request and random write request. After determining whether a buffer cache is able to support required space for performing the write request, per step 503, if the buffer cache is determined to support required space, in step 507 memory manager instructs to insert a new page into the buffer cache. If not, in step 505 memory manager enforces the buffer cache to evict a page of a victim block based on the recent history of the buffer cache eviction. Thereafter, per step 507, memory manager performs to insert a new page into the buffer cache.

FIG. 5B is a flowchart of process for selecting a victim block using a victim window associated with performance of the buffer cache management scheme, in accordance with an embodiment of the invention. As seen in FIG. 5B, in step 511, a memory manager selects a victim block using a victim window from a buffer cache based on recent page eviction first scheme, wherein the buffer cache has a victim page associated with the selected victim block. In step 513, memory manager inserts a new page by evicting the victim page from the buffer cache in consideration of the priority of the recent victim page sent to a log block of a memory system. According to an exemplary embodiment, if there is a page whose corresponding block is in victim block but is not within the victim widow, the page may enter the victim window after the eviction of other pages. Thereafter, the victim page is updated. In case there is no page in the victim page because all the victim pages are inserted into the memory system, a new victim block can be constructed.

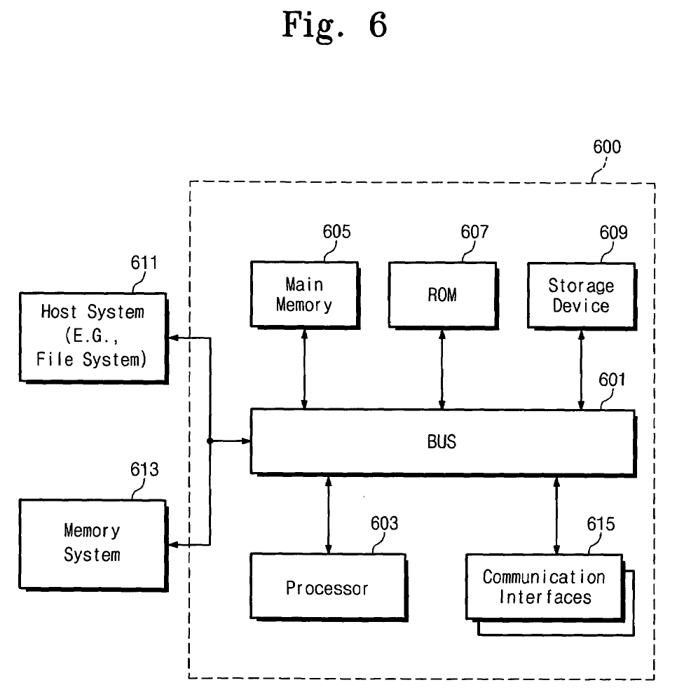

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a host system 611 (e.g., file system), such as mobile applications (e.g., PDA) and computing system such as a personal computer or an enterprise server. Memory system 613, such as a flash memory based storage devices and NAND flash-based solid state disk (SSD) may be coupled to the bus 601 for communicating information and command selections associated with write performance to the processor 603.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

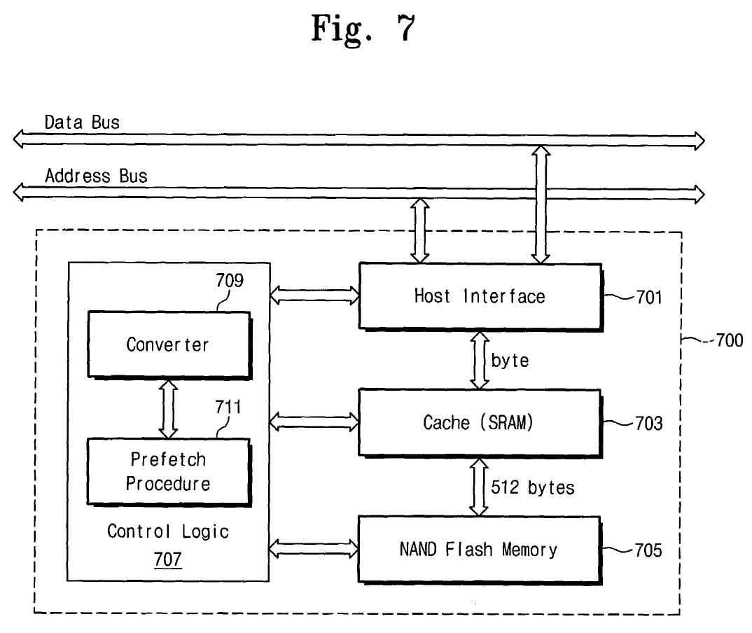

FIG. 7 is a diagram of an exemplary architecture capable of supporting various embodiments of the invention. By way of illustration, the architecture for improving performance of flash memory system 700 is explained. The system 700 comprises basic four components that are included in this hardware design 700: host interface 701, SRAM (cache) 703, NAND flash memory 705, and control logic 707. In order to fill up the performance gap between NAND and NOR flash memory, SRAM 703 serves as a cache layer for data access over NAND flash memory 705. Host interface 701 is configured responsible to the communication with the host system via address and data buses. The control logic 707, as an exemplary embodiment, can manage the caching activity and can provide the service emulation of NOR flash with NAND flash 705 and SRAM 703. It is contemplated that the control logic 707 has an intelligence prediction mechanism implemented to improve the system performance. By way of example, there are two basic components in the control logic 707. The control logic 707 includes a converter 709 which emulates NOR flash access over NAND flash with an SRAM cache 703, where address translation must be done from byte addressing (for NOR) to Logical Block Address (LBA) addressing (for NAND). It is noted that each 512 B/2 KB NAND page corresponds to one an four LBA's, respectively. A prefetch procedure 711 tries to prefetch data from NAND to SRAM so that the hit rate of the NOR access is high over SRAM.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
selecting a victim block from a buffer cache based on recent page eviction, wherein the victim block is selected in consideration of a current log block of memory; and
inserting a new page by evicting a victim page from the buffer cache in consideration of the priority of the recent victim page sent to a log block of a memory system.

2. A method according to claim 1, wherein the number of the victim block is smaller than the number of the log block.

3. A method according to claim 1, further comprising:
evicting a victim page of the victim block according to the recent history of buffer cache eviction.

4. A method according to claim 1, selecting the victim block using a victim window to prevent the recently-used page from being evicted.

5. A method according to claim 4, wherein the size of the victim window is around seventy five (75) percent of the total size of the buffer cache, wherein the victim page is selected based on the rule of the least-recently-used page.

6. A method according to claim 1, wherein the selecting the victim block is performed according to the largest number of pages of the victim block within the victim window, wherein the selection is based on the consideration of the locality of write pattern.

7. A method according to claim 1, further comprising:
a new victim block is designated if no page in the victim block.

8. A method according to claim 1, wherein the memory system includes a NAND flash.

9. An apparatus comprising:
A buffer cache manager configured to improve address mapping scheme associated with write performance between an application system and a storage device system, wherein the manager selects a victim page to be evicted from a victim block of the buffer cache according to a recently-evicted-first rule, wherein the victim block is selected associated with a log block of a storage device system.

10. An apparatus according to claim 9, the storage device system includes one of a memory system having NAND flash memory or NAND flash-based solid-state device (SSD) and the application system includes one of a cellular phone, a computer system including a personal computer or enterprise server system.

11. An apparatus according to claim 9, wherein the recently-evicted-first rule governs to consider the victim page recently sent to the log block of the storage device system.

12. An apparatus according to claim 9, wherein the number of the victim block is smaller than the number of the log block.

13. An apparatus according to claim 9, wherein the victim block is selected using a victim window to prevent the recently-used page from being evicted.

14. An apparatus according to claim 13, wherein the size of the victim window is around seventy five (75) percent of the total size of the buffer cache, wherein the victim page is selected based on the rule of the least recently-used page.

15. A computer-readable medium carrying one or more sequences of one or more instructions for improving write performance between a host system and a memory system, the one or more sequences of one or more instructions including instructions which, when executed by one or more processors, cause the one or more processors to perform the steps of:
receiving a write request;
selecting a victim block from a buffer cache according to recently-evicted-first buffer replacement rule, wherein the victim block is associated with a log block of the memory;
enforcing the buffer cache to evict a page of the victim block according to the recent history of the buffer cache eviction; and
inserting a new page into the buffer cache.

16. A computer-readable medium according to claim 15, wherein the number of the victim block is smaller than the number of the log block.

17. A computer-readable medium according to claim 15, selecting the victim block using a victim window to prevent the recently-used page from being evicted.

18. A computer-readable medium according to claim 17, wherein the size of the victim window is around seventy five (75) percent of the total size of the buffer cache, wherein the victim page is selected based on the rule of the least recently-used page.

19. A computer-readable medium according to claim 17, wherein the selecting the victim block is performed according to the largest number of pages of the victim block within the victim window.

20. A computer-readable medium according to claim 15, the memory system includes a NAND flash memory.
